(19) United States
(12) Patent Application Publication
(10) Pub. No.: US 2026/0160017 A1
(43) Pub. Date: Jun. 11, 2026

(54) ULTRASONIC WELDED CARPET SYSTEM AND METHOD

(71) Applicant: TARKETT SPORTS CANADA INC., Montreal (CA)

(72) Inventors: Eric Habib, Pierrefonds (CA); Cameron St. Dennis, Montreal (CA)

(21) Appl. No.: 19/416,751

(22) Filed: Dec. 11, 2025

Related U.S. Application Data
(60) Provisional application No. 63/730,597, filed on Dec. 11, 2024.

(51) Int. Cl. D06N 7/00; B29C 65/08; B29L 31/00

(52) U.S. Cl. CPC D06N 7/0084; B29C 65/08; B29L 2031/7322; D06N 2207/12

(57) ABSTRACT

A method of joining carpet components, including a backing and a fiber, is provided. The method includes tufting the fiber through the backing, where the fiber forms piles at a top side of the backing, and forms a staple along a bottom side of the backing opposite the top side, between consecutive iterations of the piles. The method also includes ultrasonically welding the fiber to the backing at the staple.

### CROSS-REFERENCE TO RELATED APPLICATIONS

This application claims the benefit of U.S. Provisional Application No. 63/730,597 filed Dec. 11, 2024, which is incorporated herein by reference in their entireties.

### BACKGROUND

Carpets widely produced today are typically manufactured through a variety of tufting and gluing processes where tufted fiber yarns are anchored to a backing material using adhesives which provide both mechanical retention of the fibers and, in some cases, chemical adhesion to the backing.

Polyolefins, a class of polymers valued for their softness and durability, are increasingly used in carpet manufacturing. However, polyolefin surfaces exhibit low compatibility with commonly used adhesives, limiting their adherence. To address this, polyolefin-based adhesives or chemical additives are sometimes incorporated directly into polyolefins to enable limited adhesion with conventional adhesives, such as polyurethane. Despite these measures, polyolefin carpets are typically assembled from multiple components bound by adhesive joints that are weaker than the materials themselves. This adhesive-based bonding approach can result in several issues, including susceptibility to adhesive failure, differential expansion and contraction, aging, and chemical degradation over time. Further, such adhesives tend to be thermoset materials which are hard to separate from other carpet components, including when carpet is prepared for recycling.

### BRIEF DESCRIPTION

According to one aspect, the present application describes a method of joining carpet components including a backing and a fiber fixed with the backing. The method includes ultrasonically welding a first backing portion with a second backing portion. The method also includes ultrasonically welding the fiber to the backing.

According to another aspect, a method of joining carpet components, including a backing and a fiber, is provided. The method includes tufting the fiber through the backing, where the fiber forms piles at a top side of the backing, and forms a staple along a bottom side of the backing opposite the top side, between consecutive iterations of the piles. The method also includes ultrasonically welding the fiber to the backing at the staple.

The innovation described herein describes a carpet component joining system and method that does not require dissimilar material adhesives, and increases recyclability of whole carpet. In addition to other described features, functions, and benefits, the carpet joining system and method described herein increases an overall recyclability of whole carpet, and does not require removing dissimilar materials from the carpet for starting a recycling process.

### BRIEF DESCRIPTION OF THE DRAWINGS

FIG. 1 is a bottom perspective view of an example carpet in accordance with aspects of the innovation.

FIG. 2 is a bottom perspective view of the carpet of FIG. 1 being selectively welded on a bottom side, at a staple, using an ultrasonic transducer.

FIG. 3 is a bottom perspective view of the carpet of FIG. 1 being stitch welded on the bottom side, along a stitch pattern, using the ultrasonic transducer of FIG. 2.

FIG. 4 is a top perspective view of the carpet of FIG. 1 being welded on a top side using the ultrasonic transducer of FIG. 2.

FIG. 5 is an exemplary process flow for joining carpet components in accordance with aspects of the innovation.

FIG. 6 is a top view of a weld region in the carpet of FIG. 1, in accordance with aspects of the innovation.

FIG. 7 is a top view of a weld region in the carpet of FIG. 1, in accordance with aspects of the innovation.

FIG. 8 is a top view of a weld region in the carpet of FIG. 1, in accordance with aspects of the innovation.

FIG. 9 is a cross-sectional side view of the carpet of FIG. 1.

FIG. 10 is a cross-sectional side view of the carpet of FIG. 1, including a base.

FIG. 11 is a cross-sectional side view of the carpet of FIG. 1, including a backing with a first layer and a second layer.

FIG. 12 is a cross-sectional side view of the carpet of FIG. 1, including the base and the backing with the first layer and the second layer.

FIG. 13 is a front view of the ultrasonic transducer in accordance with aspects of the innovation.

FIG. 14 is a top view of the carpet of FIG. 1, welded from the top side of the backing using the ultrasonic transducer of FIG. 13.

FIG. 15 is a bottom view of the carpet of FIG. 1, welded from the top side of the backing using the ultrasonic transducer of FIG. 13.

FIG. 16 is a front view of the ultrasonic transducer of FIG. 13, including pin-shaped energy directors.

FIG. 17 is a top view of the carpet of FIG. 1, welded from the top side of the backing using the ultrasonic transducer of FIG. 16.

FIG. 18 is a bottom view of the carpet of FIG. 1, welded from the top side of the backing using the ultrasonic transducer of FIG. 16.

FIG. 19 is a bottom perspective view of the carpet of FIG. 1, welded from the bottom side of the backing.

FIG. 20 is an enlarged bottom view of the carpet of FIG. 19, including staples.

FIG. 21 is an enlarged bottom view of the carpet of FIG. 19, including multiple layers of the backing.

FIG. 22 is an enlarged side view of the carpet of FIG. 1 being welded.

### DETAILED DESCRIPTION

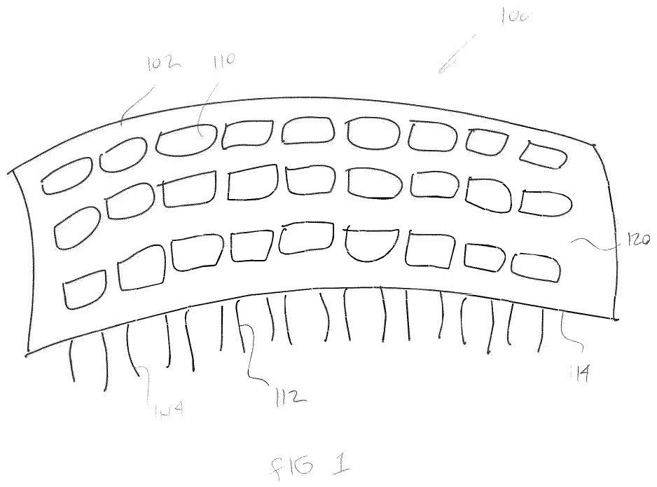

It should, of course, be understood that the description and drawings herein are merely illustrative and that various modifications and changes can be made in the structures disclosed without departing from the spirit and scope of the present disclosure. Referring now to the drawings, wherein like numerals refer to like parts throughout the several views, in accordance with an aspect of the innovation, FIG. 1 depicts a bottom perspective view of a carpet 100 including a backing 102 and fibers 104 tufted with the backing 102, forming staples 110 that respectively join the fibers 104 to the backing 102. In this regard, tufting the fibers 104 includes pushing or pulling the fibers 104 through the backing 102, where the fibers 104 form piles 112 at a top side 114 of the backing 102, and form the staples 110 along a bottom side 120 of the backing 102 opposite the top side 114. The staples 110 each respectively extend between consecutive iterations of the piles 112 in a tuft direction, that is a longitudinal direction of the carpet 100.

The staples 110 each extend through the backing 102, from the top side 114 of the backing 102 to the bottom side 120. The top side 114 of the backing 102 defines a fiber side of the carpet 100, where the staples 110 hold the piles 112. In embodiments, looping the staples 110 through the backing 102 in this manner mechanically fixes the fibers 104 at the bottom side 120 of the backing 102 prior to ultrasonically welding the fibers 104 to the backing 102. While, as depicted, the staples 110 are integrally formed portions of the fibers 104 that extend directly and continuously into the piles 112, the staples 110 may additionally or alternatively include a variety of devices such as back stitches formed separately from the fibers 104, or rigid mechanical devices including U-shaped staples, barbed staples, hog rings, retainer clips, snap fasteners, pins, tacks, rivets, grommets, cleats, anchors, serrated fasteners, or staple plates that fix the fibers 104 with the backing 102 without departing from the scope of the subject disclosure.

The components of the carpet 100, including each of the backing 102 and the fibers 104 may be formed from a same polymer family, such as polyolefins including polyethylene and polypropylene, or hydrocarbon polymers such as polyethylene and polybutadiene copolymers. In further embodiments, the components of the carpet 100 are formed from a same material, with distinct or similar polymer properties. In this regard, for example, the components of the carpet 100 may be respectively formed from high density polyethylene and low density polyethylene. As another example, the components of the carpet 100 may respectively be formed from sources of low density polyethylene having different molecular weights.

In embodiments, materials forming the components of the carpet 100 are selected from distinct, compatible polyolefin sub-families including partially or fully thermoplastic or meltable materials. For example, the backing 102 may be formed from a propylene-based polymer group, and the fibers 104 may be formed from an ethylene-based polymer group. As used herein, a “propylene-based polymer group” includes polypropylene homopolymers; and copolymers such as propylene-ethylene random copolymers and impact copolymers, amorphous polypropylene grades, and polypropylene-rich blends and alloys, including formulations with olefinic elastomers and polypropylene waxes. As used herein, an “ethylene-based polymer group” includes polyethylene homopolymers and copolymers such as high-density polyethylene (HDPE), low-density polyethylene (LDPE), linear low-density polyethylene (LLDPE), and metallocene-catalyzed PE; and ethylene-containing copolymers and elastomers such as ethylene-vinyl acetate, ethylene-butyl acrylate, ethylene-acrylic acid, and ethylene-octene elastomers. In further embodiments, the propylene-based materials forming the backing 102 and the ethylene-based materials forming the fibers 104 are selected, blended, or formulated such that resulting melting or softening temperatures are within a predetermined range suitable for welding, promoting consistent fusion between the components of the carpet 100 while preserving the respective mechanical properties of the backing 102 and the fibers 104. In embodiments where polymer blends exhibit multiple melting or softening transitions associated with distinct crystalline or amorphous phases, and welding parameters of the backing 102 or the fiber 104 may be selected at relevant transition temperatures while maintaining mechanical performance or structural integrity of the backing 102 and the fibers 104 during welding.

In embodiments, the backing 102 or the fibers 104 are formed from a blend of polypropylene and at least one of polyethylene, a propylene-ethylene random copolymer, amorphous polypropylene, an olefin elastomer, polypropylene wax, paraffinic process oils, and naphthalene. In further or alternative embodiments, the backing 102 or the fibers 104 are formed from crosslinked polyurethane that experiences surface softening under applied thermal or ultrasonic energy while retaining a non-flowable, dimensionally stable interior such that the material forming the backing 102 or the fiber 104 does not fully melt during the welding process.

As such, in various embodiments, the backing 102 and the fibers 104 are selected from materials or blends of materials, such as polypropylene or polyethylene, having melting points within, for example, 35 degrees Celsius of each other. In further embodiments the backing 102 and the fibers 104 are selected from materials or blends of materials having melting points within 30, 25, or 20 degrees Celsius of each other. In this regard, the smaller the melting or softening temperature differential, the more readily the components of the carpet 100 melt with each other, interdiffuse, and form a fusion weld. Conversely, a larger differential may enable preferentially melting the lower-melting component of the backing 102 and the fibers 104 while the higher-melting component of the backing 102 and the fibers 104 remains at least partially solid, allowing the molten phase to wet and penetrate the other component and solidify, creating an airtight composite material fixes the piles 112 to the backing 102 at the staples 110 while preserving overall structural integrity of the carpet 100 during manufacture. In this manner, the backing 102 and the fibers 104 may be made from distinct materials with tuned melting points compatible for blending in ultrasonic welding operations incorporated in manufacturing the carpet 100.

In further embodiments, the components of the carpet 100 are each formed from a same polymer, such as polyethylene, polypropylene, or polybutadiene. With this construction, the backing 102 and the fibers 104 may be assembled in the carpet 100 and joined through plastic welding, permanently fixing the backing 102 with the fibers 104 without adhesive. As such, the carpet 100 may lack any adhesive holding the backing 102 and the fibers 104, and the carpet 100 may be recycled as a whole without first removing dissimilar materials. In further embodiments, the components of the carpet 100 include different proportions of additives, such as reinforcements, fillers, pigments, antimicrobial elements, and ultraviolet (UV) resistant materials, and facilitate optimizing individual performance properties of the components of the carpet 100.

In further embodiments, welding the fibers 104 to the backing 102 may include adding a fusible interlayer of a low-melting polyolefinic interface material disposed between the backing 102 and the fibers 104, where an ultrasonic transducer may preferentially melt the interlayer, causing the interlayer to conduct heat, and promote interdiffusion and fusion bonding between the backing 102 and the fibers 104, as well as increasing the surface contact area for enhanced bonding and retention. In this regard, methods of manufacturing the carpet 100 may additionally include placing a propylene wax layer directly against the staples 110 and the backing 102 at the bottom side 120 of the backing 102 before performing the ultrasonic welding, where ultrasonically welding the fibers 104 to the backing 102 includes melting and blending the backing 102 or the fiber 104 with the propylene wax.

In embodiments of the carpet 100 including back stitches at the bottom side 120 of the carpet 100, the back stitches are also formed from the same polymer family or the same polymer as the backing 102 and the fibers 104. As such, the carpet 100 may lack any adhesive in the backing 102 and the fibers 104, including the back stitches, and the carpet 100 may be recycled as a whole without first removing dissimilar materials.

In this regard, as shown in FIG. 2, an ultrasonic transducer 200 includes a probe 202 that is a transducer horn which ultrasonically welds elements of the carpet 100 to each other. As depicted, the probe 202 extends normal to the bottom side 120 of the carpet 100, downward from a main body 204 of the ultrasonic transducer 200. The main body 204 is machine-mounted with a fixed vertical orientation, and the carpet 100 is fed under the ultrasonic transducer 200 where the probe 202 welds the backing 102 and the fibers 104. In this manner, welding the fiber 104 to the backing 102 includes placing the ultrasonic transducer 200 on the carpet 100 at the bottom side 120 of the backing 102, where the staple 110 overlaps the backing 102 in a direction normal to the backing 102. The direction normal to the backing 102 is orthogonal to the tufting direction of the fibers 104 along the backing, and orthogonal to a transverse direction along the backing 102 that is a lateral direction of the carpet 100 orthogonal to the tufting direction.

While, as depicted, the probe 202 extends downward from the main body 204 toward the backing 102 with a fixed orientation, the probe 202 and the main body 204 may alternatively be mounted on a machine in a variety of orientations, or mounted on an articulated joint that rotates the probe 202 and the main body 204 between a variety of orientations for welding the backing 102 and the fibers 104. Also, the main body 204 may additionally or alternatively be handheld and manually operated by a user at a variety of orientations with respect to the backing 102 without departing from the scope of the present disclosure.

The ultrasonic transducer 200 may selectively weld elements of the carpet 100 by targeting portions of the carpet 100 where the backing 102 and the fibers 104 are in direct contact with each other. In this regard, with continued reference to FIG. 2, the ultrasonic transducer 200 may position the probe 202 into contact with the bottom side 120 of the carpet 100, at the backing 102, where one of the staples 110 holds the fibers 104. The ultrasonic transducer 200 actuates the probe 202 to weld the one of the staples 110 to the backing 102 and the fibers 104.

As depicted, each of the staples 110 includes a base 210 at the bottom side 120 of the carpet 100, directly on the backing 102. Once welded to the backing 102, the base 210 of each staple 110 respectively defines an outer perimeter 212 along the backing 102. In an embodiment, the ultrasonic transducer 200 selectively welds the base 210 of each staple 110 to the backing 102, while retaining contiguous formation with the piles 112. More specifically, the ultrasonic transducer 200 lowers the probe 202 into contact with the base 210, spaced inward from the outer perimeter 212, where the probe 202 welds an inner portion 214 of the base 210 to the backing 102 and the fibers 104.

The inner portion 214 of the base 210 is spaced from the outer perimeter 212 in a longitudinal direction and a lateral direction of the backing 102. In an embodiment, the main body 204 exerts a downward pressure onto the backing 102 through the probe 202 to generate a welding force on the base 210 in a vertical direction perpendicular to the longitudinal direction and the lateral direction of the backing 102.

In an embodiment, the probe 202 is sized and actuated to leave the outer perimeter 212 of the base 210 at least partially solid when the corresponding inner portion 214 is welded to the backing 102 and the fibers 104. In this manner, the ultrasonic transducer 200 selectively welds the inner portion 214 with the backing 102 and the fibers 104, without melting the fibers 104 at the outer perimeter 212. While, as depicted, the fibers 104 are each formed from a single filament fiber, the fibers 104 may additionally or alternatively include yarn formed from multiple fibers spun together without departing from the scope of the present disclosure.

The carpet 100 is supported on an anvil 222, where the ultrasonic transducer 200 presses the probe 202 against the staples 110 or the backing 102, and the piles 112 are received in channels 224 defined in the anvil 222. In this regard, in embodiments, welding the fibers 104 to the backing 102 includes placing the piles 112 in the channels 224 of the anvil 222, and pressing the ultrasonic transducer 200 against the carpet 100 at a same position along the backing 102 as the anvil 222. The channels 224 structurally shield and thermally isolate the piles 112 from the probe 202 while the probe 202 welds the staples 110 to the backing 102, preventing the piles 112 from melting or experiencing mechanical wear against the anvil 222.

The channels 224 extend through the anvil 222 in the tufting direction, and are aligned with a conveyed direction of the carpet 100 over the anvil 222. With this construction, the ultrasonic transducer 200 and the anvil 222 may be arranged in a continuous production line 230 with a tufting machine that tufts the fibers 104 into the backing 102 along the tufting direction, then conveys the piles 112 through the channels 224 in the tufting direction, where the staples 110 are welded to the backing 102 against the anvil 222. As such, tufting the fibers 104 through the backing 102 and ultrasonically welding the staples 110 to the backing 102 are performed simultaneously on a same production line, that is the production line 230. In this regard, the carpet 100 is conveyed over the anvil 222 and welded at a side of the carpet 100 opposite the anvil 222, at a portion of the production line 230 subsequent to the tufting machine that performs tufting the fiber 104.

While, as depicted, the channels 224 are arranged in the tufting direction along the production line 230, the channels 224 and the conveyed direction of the carpet 100 over the anvil 222 may alternatively be independently arranged orthogonal to the tufting direction without departing from the scope of the present disclosure.

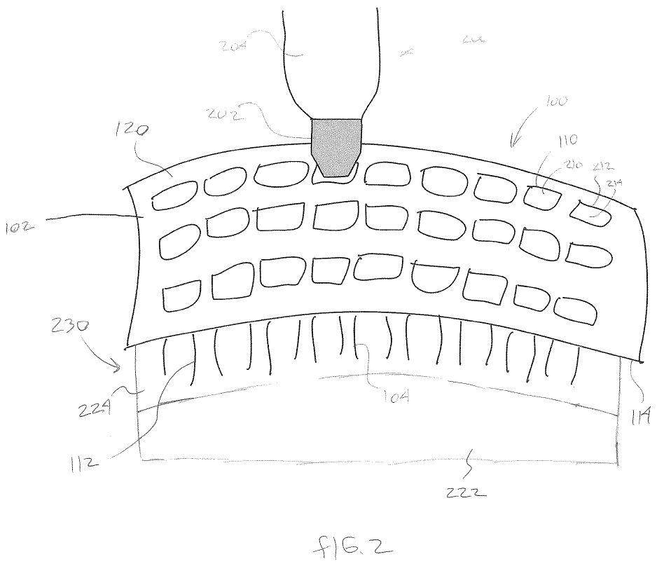

FIG. 3 depicts the ultrasonic transducer 200 welding a first backing portion 300 together with a second backing portion 302 to form the backing 102. As shown in FIG. 3, the ultrasonic transducer 200 may selectively weld elements of the carpet 100 by following a stitching pattern 304 along the backing 102. In this manner, ultrasonically welding the first backing portion 300 and the second backing portion 302 includes pressing the ultrasonic transducer 200 against the bottom side 120 of the backing 102, along the stitching pattern 304 that connects the first backing portion 300 and the second backing portion 302.

While, as depicted, the stitching pattern 304 is a straight and regular stitch weld pattern, the stitching pattern 304 may additionally or alternatively include a variety of patterns such as a zigzag stitch pattern, an offset stitch pattern, a chain stitch pattern, a skip stitch pattern, and a continuous line pattern. Also, the stitching pattern 304 may run along both the top side 114 and the bottom side 120 of the carpet 100 in a variety of patterns, such as an opposed stitch weld pattern and a staggered stitch weld pattern. Also, while the first backing portion 300 and the second backing portion 302 are depicted as joined by the ultrasonic transducer in a butt weld, the first backing portion 300 and the second backing portion 302 may additionally or alternatively be joined by the ultrasonic transducer 200 in a variety of weld types, such as a lap weld, a fillet weld, a tee weld, an edge weld, a seam weld, a slot weld, and a flange weld without departing from the scope of the present disclosure.

With continued reference to FIG. 3, the fibers 104 are tufted through the first backing portion 300 and the second backing portion 302 before the first backing portion 300 is welded to the second backing portion 302. In this manner, embodiments of manufacturing the carpet 100 include tufting the fibers 104 through the first backing portion 300 and the second backing portion 302, separate from the first backing portion 300, and then ultrasonically welding the first backing portion 300 with the second backing portion 302.

In embodiments, the ultrasonic transducer 200 adds filler material to weld sites between the backing 102 and the fibers 104, or between the first backing portion 300 and the second backing portion 302, along the stitching pattern 304. In this regard, the filler material may include additional suspended particles or other solid material of a same nature as the backing 102 and the fibers 104. More specifically, the filler material is formed from materials in a same polymer family or polymer group as the backing 102 and the fibers 104. In a further embodiment, the filler material is formed from a same polymer as the backing 102 and the fibers 104. As such, the filler material is made of a thermoplastic material of a same nature as the backing 102 or the fibers 104, resulting in a final monolithic assembly of the carpet 100. Notably, with this construction, the carpet 100 may be recycled as a whole, without first removing the filler material.

In an embodiment, the filler material includes an additive that causes the filler material to react and generate heat in response to a predetermined electromagnetic frequency. With this construction, a machine that emits the predetermined electromagnetic frequency, such as a radiofrequency generator, may selectively target the filler material among the components of the carpet 100 by inductive heating of the filler material.

In such an embodiment, the additive in the filler material may have a size and nature that absorbs radio frequencies which facilitate inductive heating in the carpet 100, such as iron oxide or other ferromagnetic materials. Additionally or alternatively, the additive in the filler material may have a bipolar nature that conveys a relatively high susceptibility to microwave irradiation, such as bipolar inorganic materials. More specifically, the additive in the filler material may include carbon-based materials such as carbon black, graphene, or carbon nanotubes. The additive in the filler material may additionally or alternatively include metallic materials such as aluminum, iron, or copper powders or oxides. The additive in the filler material may also additionally or alternatively include ceramic materials such as titanium oxide or silicon carbide, conductive polymers such as polyaniline or polypyrrole, or magnetic materials such as ferrite-based compounds. Example ferrite compounds added to the filler material include nickel ferrite, zinc ferrite, magnetite, and cobalt ferrite.

Notably, a nature, a size, and a distribution of particles forming the additive material affects the optimal electromagnetic frequency used to heat the additive material. As such, a composition of the additive material may be adjusted with at least the additive material constituents described above to adjust the optimal electromagnetic frequency. In this manner, the optimal electromagnetic frequency of the filler material may be adjusted for absorbing microwave energy without adversely surrounding components of the carpet 100. More specifically, with this construction, the additive material may determine which parts of the carpet 100 heat up during a welding process.

FIG. 4 depicts the ultrasonic transducer 200 welding the carpet 100 at the top side 114. In this regard, the ultrasonic transducer 200 locates the probe 202 in contact with the backing 102, between the fibers 104, where the ultrasonic transducer 200 welds the backing 102 with the fibers 104. As such, welding the fibers 104 to the backing 102 may include welding the staples 110 from the top side 114 of the backing 102 by placing the ultrasonic transducer 200 on the top side 114 of the backing 102, at a same position along the backing 102 as the staples 110 to be welded, between consecutive iterations of the piles 112 in the tufting direction.

In a manner similar to FIG. 2, the carpet 100 is conveyed over the anvil 222, where the ultrasonic transducer 200 presses the carpet 100 against the anvil 222, welding the staples 110 to the backing 102. As such, in various embodiments of manufacturing the carpet 100, welding the fibers 104 to the backing 102 includes placing the backing 102 and the fibers 104 over the anvil 222 with one of the top side 114 and the bottom side 120 of the backing 102 facing the anvil 222, and placing the ultrasonic transducer 200 at the other of the top side 114 and the bottom side 120 of the backing 102, at a same position as the anvil 222 along the backing 102.

In embodiments, the backing 102 has a higher melting point than the fibers 104, such that ultrasonically welding the fibers 104 to the backing 102 avoids melting the backing 102 as compared to the fibers 104, and causes the staples 110 to melt around and interlock with the backing 102. In alternative embodiments, the fibers 104 have a higher melting point than the backing 102, which prevents the piles 112 from melting with the staples 110 as the staples 110 are blended into the backing 102.

As shown in FIG. 4, the carpet 100 may include a base 400 that is an additional support layer formed from fabric or film. The base 400 is added to the backing 102 at the bottom side 120 in a manner that covers the bases 210 of the staples 110, and conveys strength and rigidity to the carpet 100 through the backing 102. The base 400 may include similar features, and function in a similar manner as the backing 102 for increasing structural integrity of the carpet 100. In this regard, as a component of the carpet 100, the base 400 may be formed from a same polymer family or a same polymer as the backing 102 and the fibers 104. With this construction the carpet 100, including the base 400, may be recycled as a whole without first removing dissimilar materials. Also, the ultrasonic transducer 200 may plastic weld the base 400 to the backing 102 and the fibers 104 as components of the carpet 100. In this manner, various embodiments of manufacturing the carpet 100 include layering the base 400 with the backing 102 at a side of the backing 102 opposite the piles 112, where the staples 110 are interposed between and separate the base 400 and the backing 102 in the direction normal to the backing 102.

In certain embodiments, the base 400 has a melting temperature or a softening temperature higher than that of the backing 102 or the fibers 104. With this construction, the base 400 thereby remains dimensionally stable and functions as a thermal and mechanical shield, limiting surface marking, melting, or deformation at an exterior surface of the carpet 100 while permitting localized fusion of the backing 102 and the fibers 104 at the staples 110.

In an alternative embodiment, the staples 110 extend through both the backing 102 and the base 400. In such an embodiment, the ultrasonic transducer 200 may ultrasonically weld the staples 110 directly to the base 400. In further embodiments, the carpet 100 includes a plurality of base layers including the base layer 400. With this construction, the greater number of base layers supporting the backing 102 provides additional weld interfaces for the fibers 104, and improves dimensional stability and load distribution, enhancing structural integrity of the carpet 100 during handling and manufacture, including during ultrasonic welding operations.

Notably, the ultrasonic transducer 200 may be employed on-site at the carpet 100, including, for example, where the carpet 100 is an artificial turf field. In this regard, the ultrasonic transducer 200 may be employed to weld the backing 102 and the fibers 104 as components of the carpet 100 for on-site assembly and repairs. While, as depicted, the carpet 100 is part of an artificial turf field, the carpet 100 may embody a variety of carpet types, such as residential carpet, commercial carpet, hospitality carpet, automotive carpet, industrial carpet, and temporary event carpet without departing from the scope of the present disclosure.

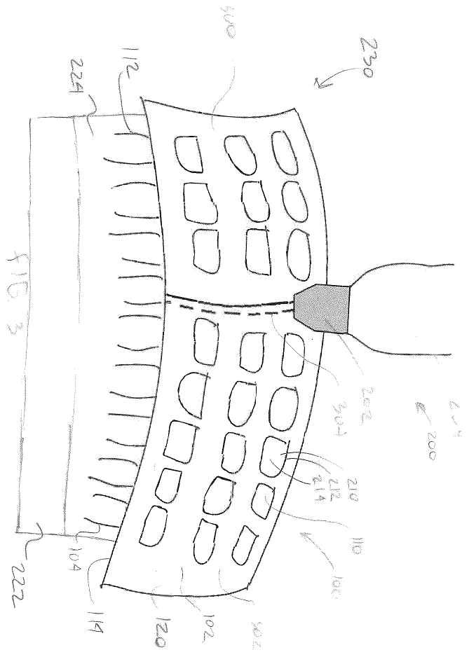

FIG. 5 depicts a method 500 for assembling the carpet 100, including plastic welding the carpet 100 using the ultrasonic transducer 200. FIG. 5 will be described with reference to FIGS. 1-4. For simplicity, the method 500 will be described with reference to a depicted sequence of blocks which respectively correspond to steps in the method 500, but the elements of the method 500 may be organized in different orders, architectures, stages, and/or processes.

Referring to FIG. 5, at block 502 the method 500 includes tufting the fibers 104 through the backing 102, and fixing the fibers 104 to the backing 102 at the staples 110. In this regard, tufting the fibers 104 includes pushing or pulling the fibers 104 through the backing 102, where the fibers 104 form piles 112 at the top side 114 of the backing 102 with a desired texture, density, and design, and form the staples 110 along the bottom side 120 of the backing 102 between consecutive iterations of the piles 112 in the tuft direction. Looping the staples 110 through the backing 102 in this manner mechanically fixes the fibers 104 at the bottom side 120 of the backing 102 prior to ultrasonically welding the fibers 104 to the backing 102.

At block 504 the method includes welding the backing 102. In this regard, welding the backing 102 includes welding the first backing portion 300 and the second backing portion 302 to form the backing 102. Welding the backing 102 may be performed on-site with the ultrasonic transducer 200, where the probe 202 follows the stitching pattern 304 or selectively targets portions of the first backing portion 300 and the second backing portion 302. In an embodiment where the backing 102 is part of the carpet 100 in an artificial turf field, welding the backing 102 includes welding together edges of the first backing portion 300 and the second backing portion 302 in a butt weld.

At block 510 the method 500 includes welding the fibers 104 to the backing 102 at the staples 110. Welding the fibers 104 to the backing 102 at the staples 110 includes positioning the probe 202 in contact with the backing 102 and the staple 110 at the bottom side 120 of the carpet 100. In an embodiment, the method 500 includes controlling the probe 202 with a shape and power output that limits welding the fibers 104 locally at the staples, to components of the carpet 100 at the inner portion 214 of the base 210 of the staple 110.

Welding the fibers 104 at block 510 may be performed with a variety of weld patterns along the stitching pattern 304. In this regard, FIG. 6 depicts an embodiment of the method 500 at block 510 that includes performing a continuous weld along the stitching pattern 304 using a horn geometry with a substantially flat welding face that forms a continuous weld region 600 between the components of the carpet 100. In such an embodiment of block 510, the ultrasonic transducer 200 may position a planar contact surface of the probe 202 centered over the inner portion 214 of the base 210 of the staple 110, and drive the probe 202 along the tufting direction, forming the weld region 600 with an elongated, generally rectangular shape. In an alternative embodiment, the ultrasonic transducer 200 drives or rolls the probe 202 along the backing 102 and the staples 110 in the lateral direction.

In an embodiment, the continuous weld region is laterally bounded within the outer perimeter 212 of the base 210 such that welding is localized to the inner portion 214, preserving at least a margin of material at the outer perimeter 212 that maintains structural integrity of the fibers 104 during welding operations. With this construction, the probe 202 may produce a continuous weld in the weld region 600 that increases fused area and anchoring strength relative to discrete or intermittent patterns, while the anvil 222 and the selective placement of the probe 202 at the inner portion 214 limit heat exposure to the piles 112 and the backing 102 outside the weld region 600. The weld region 600 may be formed from the bottom side 120 by contacting the base 210 directly, or from the top side 114 by locating the probe 202 between adjacent piles 112 at the same position as the staple 110 along the backing 102, as described above with respect to FIG. 4.

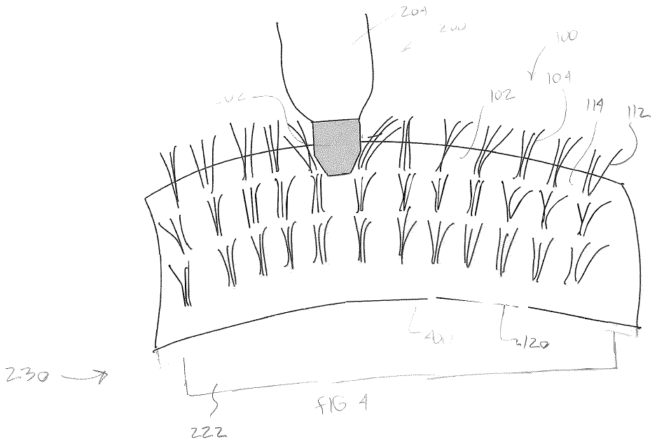

FIG. 7 depicts an alternative embodiment of the carpet 100 including a patterned weld region 700 formed along the staple path at block 510 using a wheel-type embodiment of the probe 202 having a patterned welding face disposed around a wheel. In this regard, the ultrasonic transducer 200 positions the probe 202 where patterned contact features of the wheel are centered over the inner portion 214 of the base 210 of the staple 110. The ultrasonic transducer 200 advances the probe 202 along the tufting direction relative to the backing 102 on the production line 230, creating a series of intermittent, discrete weld features within a patterned weld region 700. The weld region 700 fuses the staple 110 to the backing 102 at the inner portion 214 while maintaining an un-welded margin proximate the outer perimeter 212. In an embodiment, the patterned contact features of the probe 202 define a duty cycle in which a portion of the stitch pattern 304 is fused and a portion is left unfused in a regular or predetermined pattern coinciding with the staples 110.

As shown in FIG. 7, the weld region 700 includes relatively small rectangular weld areas as compared to the continuous weld region 600 of FIG. 6, and are spaced from each other in the tufting direction. With this construction, the ultrasonic transducer 200 reduces an overall heat input into the carpet 100 and preserves fiber integrity relative to a continuous weld region, while providing sufficient anchoring strength for the fibers 104 at the staples 110. The weld region 700 may be formed from the bottom side 120 by contacting the base 210 directly with the patterned wheel, or from the top side 114 by locating the patterned wheel between adjacent piles 112 at the same position as the staple 110 along the backing 102, as described above with respect to FIG. 4. In practice, the geometry of the patterned welding face and the power output of the probe 202 may be selected to localize welding to the inner portion 214, to balance anchoring strength with aesthetic and tactile preservation of the piles 112, and to maintain dimensional stability of the backing 102.

FIG. 8 depicts an alternative embodiment of the carpet 100 including a patterned weld region 800 formed along the stitching pattern 304 at block 510 using the probe 202. In this regard, the ultrasonic transducer 200 positions the probe 202 so that patterned contact features are centered over the inner portion 214 of the base 210 of the staple 110 and advances the probe 202 relative to the backing 102 on the production line 230, creating the weld region 800 with intermittent, discrete weld features arranged in a predetermined pattern.

As shown in FIG. 8, the weld region 800 is formed from weld lines that are angled along the tufting direction, and overlap in both the tufting direction and the lateral direction along the backing 102, forming a regular weld pattern along the stitching pattern 304. With this construction, corresponding patterned contact features of the probe 202 may define a duty cycle that is lower than that of FIG. 7, such that a smaller fraction of the stitching pattern 304 is fused and a larger fraction remains unfused, further reducing an overall heat input into the carpet 100 from the ultrasonic transducer 200 and enhancing preservation of fiber integrity, while maintaining sufficient anchoring strength at the staples 110 as compared to the weld region 700 of FIG. 7. The patterned weld region 800 may be formed from the bottom side 120 by contacting the base 210 directly with the probe 202, or from the top side 114 by locating the probe 202 between adjacent piles 112 at the same position as the staple 110 along the backing 102, as described above with respect to FIG. 4.

In practice, the selection of the patterned contact geometry and the power output of the probe 202 may be used to localize welding to the inner portion 214 and to tune the balance between fused area (and corresponding anchoring strength) and the aesthetic and tactile preservation of the piles 112, consistent with the tradeoff that increased welded area generally improves joint strength at the expense of fiber integrity.

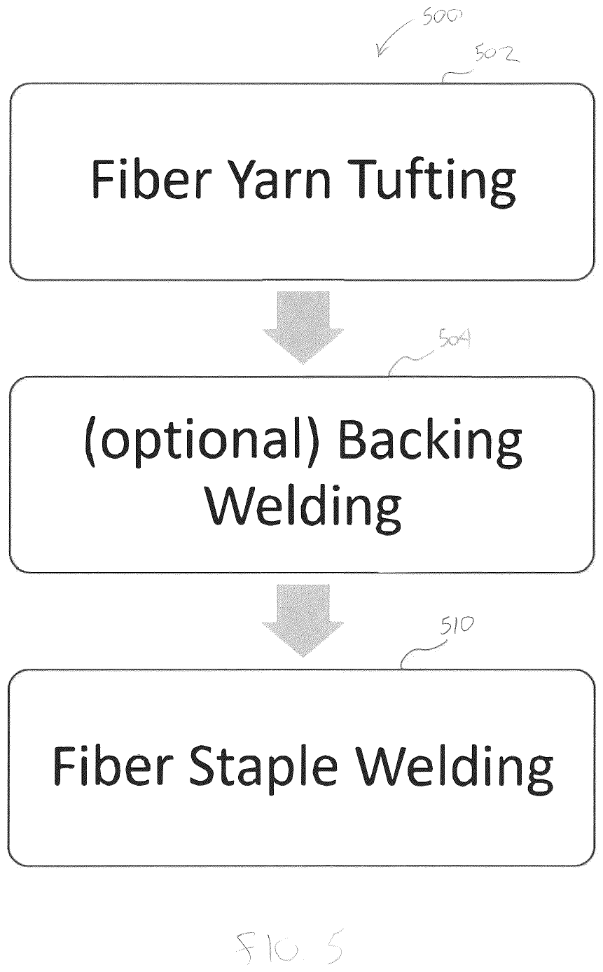

The backing 102 or the base 400 may include multiple layers that are welded or tufted to each other or the staples 110. In this regard, FIG. 9 depicts an embodiment of the carpet 100 including the piles 112 tufted through the backing 102 along the tufting direction, forming a staple 110 at the bottom side 120 of the backing 102. FIG. 10 depicts an embodiment of the carpet 100 including the base 400 layered along and against the bottom side 120 of the backing 102, sandwiching the staple 110 against the backing 102. The base 400 may be welded or mechanically fixed to the backing 102 or the staple 110, further fixing the pile 112 at the staple 110.

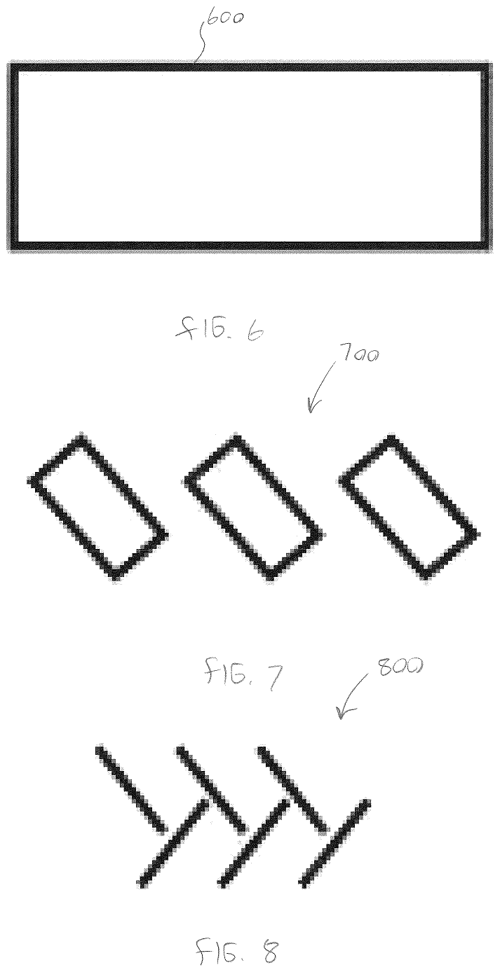

FIG. 11 depicts an embodiment of the carpet 100 where the backing includes a first layer 1100 and a second layer 1102, and the fibers 104 are tufted through both the first layer 1100 and the second layer 1102, forming the staple 110 along the bottom side 120 of the backing 102, against the second layer 1102, at a side of the backing 102 opposite the first layer 1100. While, as depicted, the backing 102 includes a plurality of layers through which the fibers 104 are tufted, including the first layer 1100 and the second layer 1102, the base 400 may additionally or alternatively include a plurality of layers through which the fibers 104 are tufted without departing from the scope of the present disclosure.

FIG. 12 depicts an embodiment of the carpet 100 including the backing 102 with the first layer 1100 and the second layer 1102, and the base 400 sandwiching the staple 110 with the backing 102. The first layer 1100, the second layer 1102, the staple 110, or the base 400 may be welded with each other at the staple, creating a weld region that extends through the carpet 100 or a portion thereof. In further embodiments, the first layer 1100, the second layer 1102, the staple 110, or the base 400 are selectively and mechanically fixed with each other by the staples 110. While, as depicted, the piles 112 are cut piles that extend from the backing 102 as individual strands of the fibers 104, the piles 112 may additionally or alternatively include looped piles fixed with the staples 110 and extended from the backing 102 without departing from the scope of the present disclosure.

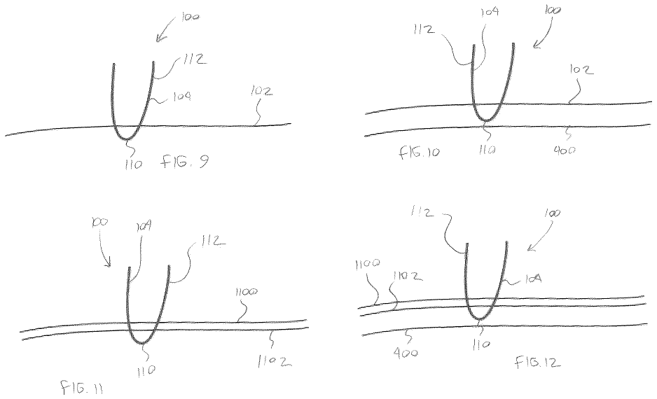

FIG. 13 depicts an embodiment of the ultrasonic transducer 200, including the probe 202 formed as an ultrasonic horn for delivering vibratory energy to components of the carpet 100 during welding operations. In the illustrated embodiment, the probe 202 includes a distal welding face 1300 sized and shaped to contact the backing 102 at a staple 110, and tapered sidewalls 1302 that transition from the welding face to a shank portion 1304 coupled with the main body 204. The geometry of the probe 202 concentrates ultrasonic energy at an interface between the piles 112 at backing 102 and the staples 110, while limiting cutting, tearing, or excessive deformation of the piles 112. While shown as having a substantially planar welding face, the probe 202 may include alternative face geometries, surface textures, or contoured profiles, and may be configured for continuous or patterned welding, depending on a desired weld width, energy distribution, or degree of localization at the staple 110, between the piles 112, without departing from the scope of the present disclosure.

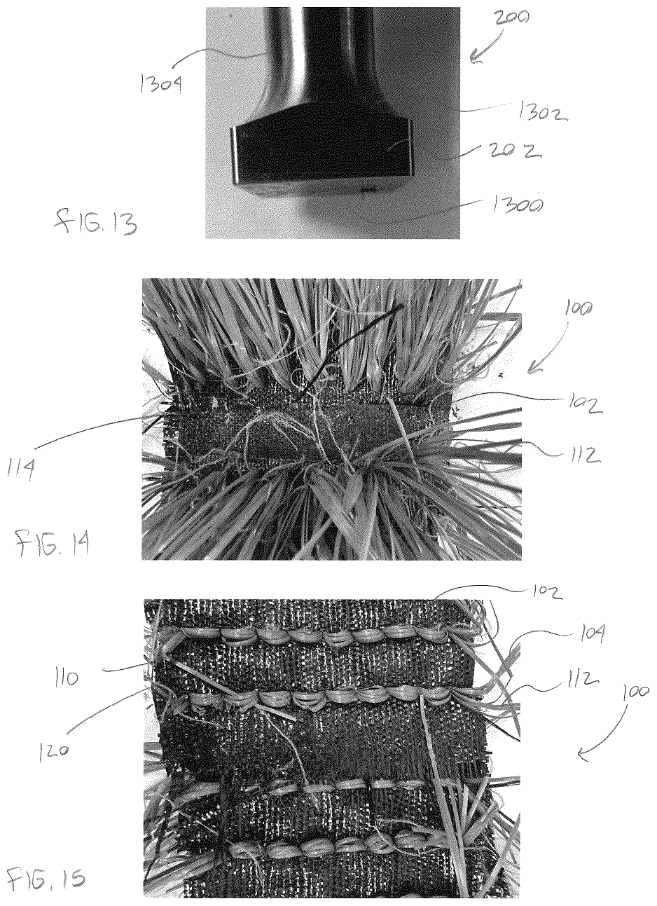

FIGS. 14 and 15 depict an embodiment of the carpet 100 after ultrasonic welding the components of the carpet 100 from the top side 114 using the ultrasonic transducer 200 of FIG. 13. In this regard, with reference to FIGS. 14 and 15, the probe 202 of FIG. 13 was applied between consecutive iterations of the piles 112, where the probe 202 delivers ultrasonic energy through the top side 114 of the backing 102, such that the staples 110 extending through the backing 102 are fused with the backing 102 and the fibers 104 without requiring any adhesive. Weld regions 1400 formed by the probe 202 are localized between the piles 112 and below the exposed portions of the fibers 104, such that the piles 112 retain their upright orientation, texture, and separation while the underlying staple 110 is immobilized relative to the backing 102. As shown, the weld regions 1400 include the staples 110 blended into a matrix of filaments forming the backing 102. In this manner, FIGS. 14 and 15 illustrate permanent fixation between the backing 102 and the fibers 104 by ultrasonic welding from the top side 114, anchoring the piles 112 at the staples 110 while maintaining the visual appearance and tactile characteristics of the carpet 100.

FIG. 16 depicts an embodiment of the ultrasonic transducer 200 including the probe 202 including a plurality of pin-shaped energy directors 1600 extending toward the carpet 100 from the distal welding face 1300. As depicted, the energy directors 1600 are sized, shaped, and arranged to penetrate into the backing 102 from the top side 114 when the probe 202 is applied between adjacent piles 112. The energy directors 1600 concentrate ultrasonic energy over smaller contact areas relative to a planar welding face, increasing localized energy density and promoting transmission of vibratory energy through the backing 102 toward the staples 110 at the bottom side 120. With this construction, the probe 202 is configured to preferentially deliver ultrasonic energy to the staples 110 extending through the backing 102, while limiting lateral heat spread into surrounding regions of the piles 112.

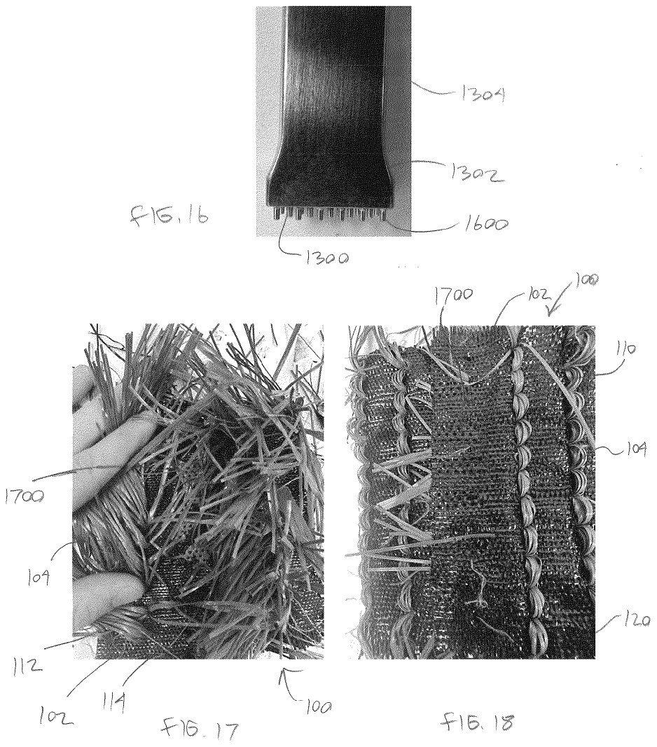

FIGS. 17 and 18 depict the carpet 100 after performing ultrasonic welding from the top side 114 using the probe 202 of FIG. 16. As depicted, ultrasonic energy delivered by the pin-shaped energy directors 1600 penetrates the backing 102, causing the staples 110 to soften, melt, and flow through the backing 102. In this regard, the staples 110 blend through and around the filaments forming the backing 102, and then resolidify into a composite material region 1700 in which the fibers 104 and the backing 102 are interlocked, with the backing 102 functioning as a substrate embedded within the fused staple material, anchoring the piles 112 at the staples 110.

As shown in FIG. 17, the composite material region 1700 extends through the backing 102 toward the top side 114, indicating effective transmission of ultrasonic energy from the top side 114 to the staple 110. The fused region immobilizes the fibers 104 relative to the backing 102 without requiring any adhesive and without collapsing or matting the piles 112 above the backing 102. In this manner, FIGS. 17 and 18 illustrate an embodiment of the carpet 100 in which increased energy penetration provided by the energy directors 1600 of FIG. 16 enhances fusion of the staples 110 through the backing 102, producing a mechanically robust, monolithic joint between the fibers 104 and the backing 102 while preserving the visual and tactile characteristics of the carpet 100 at the piles 112.

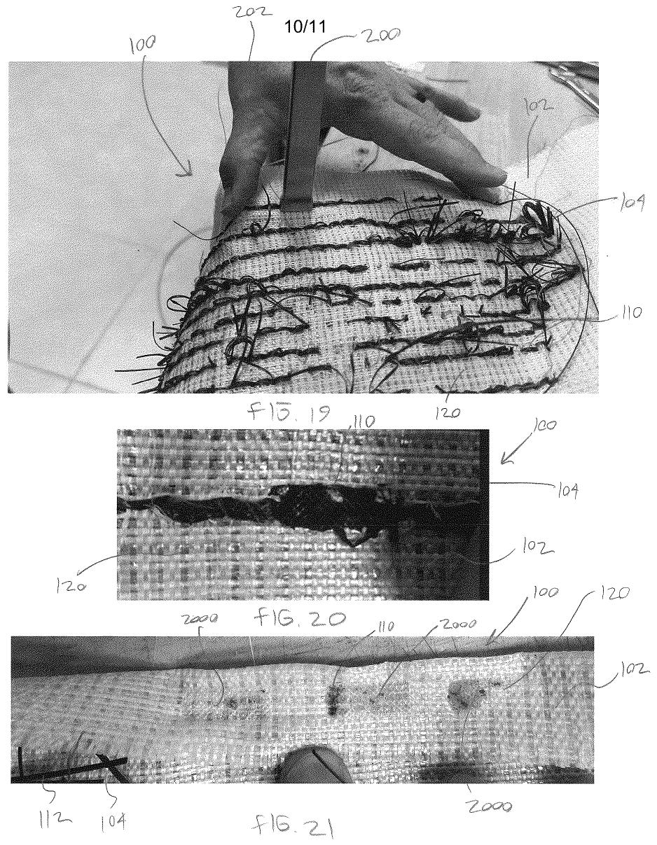

FIG. 19 depicts an embodiment of the carpet 100 during ultrasonic welding from the bottom side 120 using the ultrasonic transducer 200. As depicted, the probe 202 is applied against the bottom side 120 of the backing 102 in the tufting direction at locations corresponding to the staples 110. The probe 202 transfers energy directly into the staples 110 and adjacent portions of the backing 102, causing the staples 110 to soften and flow into surrounding filaments forming the backing 102. In this manner, ultrasonic welding from the bottom side 120 fuses the staples 110 with the backing 102 while the piles 112 at the top side 114 are spatially separated from the probe 202 and remain thermally and mechanically isolated during welding.

FIG. 20 depicts the carpet 100 after ultrasonic welding from the bottom side 120. As shown, the staples 110 are blended with filaments forming the backing 102, defining a composite material region 2000 in which material from the fibers 104 and the backing 102 is intermixed and resolidified. With this construction, the staples 110 are immobilized relative to the backing 102 without requiring any adhesive, and a monolithic joint is formed that resists pull-out and shear forces applied through the piles 112.

FIG. 21 depicts an embodiment of the carpet 100 after ultrasonic welding in which the backing 102 is layered against itself over the staples 110 and welded. In this regard, portions of the backing 102 are folded, overlapped, layered, or otherwise brought into contact at the bottom side 120 such that the staples 110 are disposed between layered portions of the backing 102. Ultrasonic energy applied at the bottom side 120 from the probe 202 causes the backing 102 to melt and fuse to itself over the staples 110, encapsulating the staples 110 within the welded material of the backing 102. As shown, this construction produces a continuous backing region over the staples 110 while maintaining anchorage of the fibers 104, further reinforcing the mechanical fixation of the piles 112 and forming a unified structure suitable for recycling as a whole.

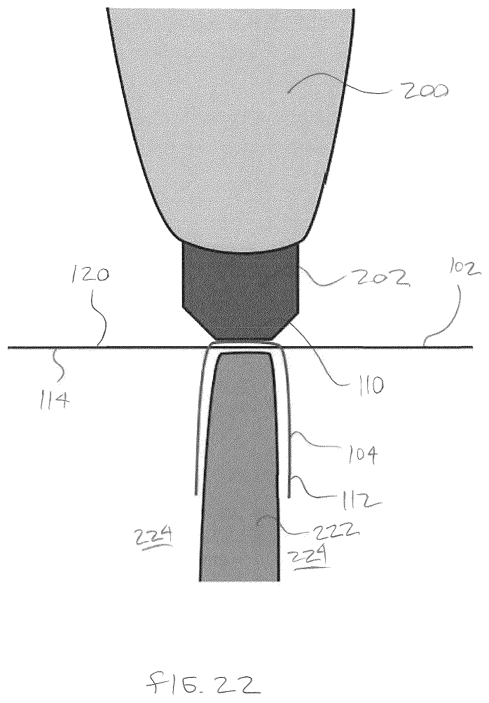

FIG. 22 depicts an enlarged side view of the carpet 100 during ultrasonic welding using the ultrasonic transducer 200 in accordance with the embodiments described above. As shown, the probe 202 is positioned against one of the staples 110 at the bottom side 120 of the backing 102, opposite the anvil 222 at the top side 114. The probe 202 is oriented normal to the backing 102 and applies ultrasonic energy into the staple 110 and adjacent portions of the backing 102. In the illustrated view, opposite portions of the fibers 104 forming the staples 110 extend downward into the piles 112 at the top side 114 of the backing 102, while the probe 202 contacts the bottom side 120 to effect localized fusion at the staple 110. With this construction, the piles 112 are positioned at opposite sides of the anvil 222 in the tufting direction, which may define the channels 224, thermally and mechanically isolating the piles 112 from the ultrasonic transducer 200, including the probe 202, during welding.

Although the subject matter has been described in language specific to structural features or methodological acts, it is to be understood that the subject matter of the appended claims is not necessarily limited to the specific features or acts described above. Rather, the specific features and acts described above are disclosed as example aspects. Various operations of aspects are provided herein. The order in which one or more or all of the operations are described should not be construed as to imply that these operations are necessarily order dependent. Alternative ordering will be appreciated based on this description. Further, not all operations may necessarily be present in each aspect provided herein.

As used in this application, “or” is intended to mean an inclusive “or” rather than an exclusive “or”. Further, an inclusive “or” may include any combination thereof (e.g., A, B, or any combination thereof). In addition, “a” and “an” as used in this application are generally construed to mean “one or more” unless specified otherwise or clear from context to be directed to a singular form. Additionally, at least one of A and B and/or the like generally means A or B or both A and B. Further, to the extent that “includes”, “having”, “has”, “with”, or variants thereof are used in either the detailed description or the claims, such terms are intended to be inclusive in a manner similar to the term “comprising”.

Further, unless specified otherwise, “first”, “second”, or the like are not intended to imply a temporal aspect, a spatial aspect, an ordering, etc. Rather, such terms are merely used as identifiers, names, etc. for features, elements, items, etc. For example, a first channel and a second channel generally correspond to channel A and channel B or two different or two identical channels or the same channel. Additionally, “comprising”, “comprises”, “including”, “includes”, or the like generally means comprising or including, but not limited thereto.

Further, the term “in” as used to describe an object with respect to a given direction (e.g., an edge extended in a left-right direction) is intended to denote an orientation that is substantially parallel to the specified direction. In contrast, the term “along” as used to describe an object with respect to a given direction (e.g., an edge extended along a vertical direction) is intended to indicate that a feature or element possesses a common vector component in that direction, even if its overall alignment is not strictly parallel.

It will be appreciated that various embodiments of the above-disclosed and other features and functions, or alternatives or varieties thereof, may be desirably combined into many other different systems or applications. Also, that various presently unforeseen or unanticipated alternatives, modifications, variations or improvements therein may be subsequently made by those skilled in the art which are also intended to be encompassed by the following claims.

1. A method of joining carpet components including a backing and a fiber, the method comprising:
tufting the fiber through the backing, where the fiber forms piles at a top side of the backing, and forms a staple along a bottom side of the backing opposite the top side, between consecutive iterations of the piles; and
ultrasonically welding the fiber to the backing at the staple.

2. The method of claim 1, wherein welding the fiber to the backing includes welding the staple from the top side of the backing by placing an ultrasonic transducer on the top side of the backing, at a same position along the backing as the staple, between the piles.

3. The method of claim 1, wherein welding the fiber to the backing includes placing an ultrasonic transducer on the carpet at the bottom side of the backing, where the staple overlaps the backing in a direction normal to the backing.

4. The method of claim 3, wherein welding the fiber to the backing includes placing the piles in a channel of an anvil, and pressing the ultrasonic transducer against the carpet at a same position along the backing as the anvil.

5. The method of claim 1, wherein welding the fiber includes placing the backing and the fiber over an anvil with one of the top side and the bottom side facing the anvil, and placing an ultrasonic transducer at the other of the top side and the bottom side of the backing, at a same position as the anvil along the backing.

6. The method of claim 1, further comprising layering a base with the backing at a side of the backing opposite the piles, where the staple is interposed between and separates the base and the backing in a direction normal to the backing.

7. The method of claim 6, further comprising ultrasonically welding the base to the staple or the backing.

8. The method of claim 1, wherein tufting the fiber through the backing includes tufting the fiber through a first backing portion and a second backing portion separate from the first backing portion, and the method further comprises ultrasonically welding the first backing portion with the second backing portion.

9. The method of claim 8, wherein ultrasonically welding the first backing portion and the second backing portion includes joining the first backing portion and the second backing portion together in a butt joint or a lap joint after tufting the fiber through the first backing portion and the second backing portion.

10. The method of claim 8, wherein ultrasonically welding the first backing portion and the second backing portion includes pressing an ultrasonic transducer against the bottom side of the backing along a stitching pattern that connects the first backing portion and the second backing portion.

11. The method of claim 1, further comprising forming the backing or the fiber from a blend of polypropylene or polyethylene, wherein the backing and the fiber have melting points within 35 degrees Celsius of each other.

12. The method of claim 1, further comprising forming the backing or the fiber from a blend of polypropylene and at least one of:
polyethylene;
a propylene-ethylene random copolymer;
amorphous polypropylene;
an olefin elastomer;
polypropylene wax;
paraffinic process oils; and
naphthalene.

13. The method of claim 1, further comprising placing a propylene wax layer directly against the staple or the bottom side of the backing before performing the ultrasonic welding, wherein ultrasonically welding the fiber to the backing includes melting and blending the backing or the fiber with the propylene wax.

14. The method of claim 1, wherein tufting the fiber through the backing and ultrasonically welding the fiber to the backing are performed simultaneously on a same production line, where the carpet is conveyed over an anvil and welded at a side of the carpet opposite the anvil, at a portion of the production line subsequent to performing tufting the fiber.

15. The method of claim 1, wherein the backing and the fiber are formed from materials in a same polymer group that is at least one of a propylene-based polymer group and an ethylene-based polymer group.

16. The method of claim 1, wherein the backing is formed from a propylene-based polymer group and the fiber are formed from an ethylene-based polymer group.

17. The method of claim 1, wherein the backing and the fiber are both formed from polyolefins.

18. The method of claim 1, wherein the fiber and the backing are assembled in the carpet without an adhesive.

19. The method of claim 1, further comprising:
adding a filler material to a weld site including the backing or the fiber; and
exciting the filler material with electromagnetic radiation, causing the filler material to generate heat.

20. The method of claim 19, wherein the electromagnetic radiation is a radio frequency emission or a microwave frequency emission having a predetermined frequency, and the filler material includes an additive that absorbs electromagnetic radiation having the predetermined frequency.
